(19) United States
(12) Patent Application Publication
(10) Pub. No.: US 2023/0062360 A1
(43) Pub. Date: Mar. 2, 2023

(54) Vibrating Garment to Reduce Muscle Pain During Intense Exercise

(71) Applicant: Greg Rose, Littleton, CO (US)

(72) Inventor: Greg Rose, Littleton, CO (US)

(21) Appl. No.: 17/511,690

(22) Filed: Oct. 27, 2021

Related U.S. Application Data
(60) Provisional application No. 63/237,689, filed on Aug. 27, 2021.

(51) Int. Cl. A41D 1/00; A61H 23/02

(52) U.S. Cl. CPC A41D 1/002; A61H 23/02; A41D 2400/322

(57) ABSTRACT

The claimed subject matter relates novel method and apparatus for dulling non -injury associated, exercise induced pain using a new vibrational device. Provided is a wearable garment for reduction of muscle pain during intense physical exercise, comprising a garment adapted to conform to a shape of a portion of a human body; a plurality of interconnected vibrators and incorporated into the garment at intervals throughout the garment; a power source coupled to the plurality of vibrators; an instruction execution system; logic, executed on the instruction execution system and stored on a non -transitory storage medium, the logic comprising instructions for controlling the plurality of vibrators to deliver vibrations to the portion of the human body during exercise.

### CROSS-REFERENCES TO RELATED APPLICATIONS

The present application claims the benefit of the filing date of a provisional application entitled, “Vibrating Garment to Reduce Muscle Pain During Intense Activity” Serial No.63/237,689, filed Aug. 27, 2021, assigned to the assignee of the present application, and herein incorporated by reference.

### FIELD OF THE DISCLOSURE

The claimed subject matter relates novel method and apparatus for dulling non-injury associated, exercise induced pain using a new vibrational device. Disclosed techniques utilize the value of effective exercise and the physiology of exercise pain to provide a new approach to gate control theory utilizing the mechanics of a device that reduces pain allowing a user to achieve the desired complete muscle fatigue.

### BACKGROUND

Statistics on American health and exercise indicate that only about twenty-three percent (23%) of American adults meet leisure-time physical activity (LTPA) guidelines, according to research data from the Center for Disease Control’s (CDC) National Center for Health Statistics. (National Health Statistics Reports Number 112 v. Jun. 28, 2018). The U.S. Department of Health and Human Services recommends that adults between the ages of eighteen and sixty-four (18-64) engage in at least one hundred fifty (150) minutes of moderate physical activity or seventy-five (75) minutes of vigorous physical activity every week. As health is a growing issue for adults and of financial concern for insurance companies, we seek to find ways to lower barriers to allow people to exercise more frequently, effectively, vigorously, and safely.

It is well known that exercise is important and recommended for all able-bodied people. Regular exercise can fend off heart disease and improve circulation. It helps prevent type 2 diabetes as muscles stay more receptive to insulin. It has been suggested it can lower the risk of cancer: colon, breast, endometrial, and maybe ovarian. It has also been shown to reduce the risk of recurrence of colon and breast cancer. Symptoms of depression can be reduced with exercise and perhaps delay the onset of cognitive decline into dementia.

Usually, pain is a medically important warning (useful) that something is wrong. During exercise, pain can be induced by ligament tears, joint injury, sprains, and rarely fractures. While unpleasant, these types of pain are essential alerting the athlete to stop doing what he’s doing to avoiding injury or worsening a condition.

However, there is also pain associated with the last few repetitions (reps) during a workout set due to lactic acid buildup. Lactic acid is produced during a workout causing a reducing in pH sensed by nerves and transmitted as pain to the brain. This is the “burn” sensation in muscles toward the end of a vigorous workout set. When the body exercises at its greatest capacity, the muscles are not able to get enough oxygen to convert food to energy, causing lactic acid to be produced and built up in the muscle, leading to the burning feeling. It is the temporarily lactic acid buildup and resulting pain that can discourage the athlete from exercising further through the crucial additional reps.

Under usual circumstances, our bodies preferentially rely on aerobic mechanisms but when the exercising athlete demands energy on a faster scale, the body cannot recruit oxygen fast enough forcing our muscles to resort to anaerobic methods. In this case, glycolysis breaks down glucose into pyruvate. If there’s enough oxygen, pyruvate breaks down more along an aerobic pathway to generate more energy, but if oxygen is low, pyruvate converts temporarily to lactate allowing energy production through glucose breakdown. The muscle can now keep working a bit longer, but lactate will build up around the muscles. In this acid environment, surrounding metabolites work poorly shutting down muscle function leading to muscle fatigue. This protective process keeps the muscle cells from damage but getting to this point is of great importance in building muscle. Once the muscle stops working, lactate reverts to pyruvate (pain rapidly subsides) and aerobic metabolism can resume leading to muscle recovery. Lactate (lactic acid) is responsible for this temporary burning but not for delayed muscle soreness.

Some authors have emphasized the muscle building value of the last three reps knowing these hurt but count the most. For most athletes and casual trainees, the last three reps are elusive due to the extreme associated pain. When the muscle is about to fatigue, positive, crucial building processes occur including the release of lipase, the enzyme that promotes fat breakdown, the release of testosterone and growth hormone aiding in increasing lean body mass, fat burning, and recovery. These are the most sought-after results in building lean muscle.

### SUMMARY

The claimed subject matter relates novel method and apparatus for dulling non-injury associated, exercise induced pain using a new vibrational device. Disclosed techniques utilize the value of effective exercise and the physiology of exercise pain to provide a new approach to gate control theory utilizing the mechanics of a device that reduces pain allowing a user to achieve the desired complete muscle fatigue.

There are many reasons why adults who could exercise don’t such as boredom, time consumption, expense, no results, and pain. It is our belief that if we can improve the last two, no results and pain, more people might overcome the rest. Specifically, the disclosed techniques reduce the pain of muscular fatigue allowing a user to exercise further then they otherwise would thus generating the greatest results.

Comprehensive physiological discussion of pain is beyond the scope of this disclosure so it will be limited to a discussion of pain on a new approach to gate control theory related to the relevant pain and vibration pathways.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

In the following brief description, reference is made to accompanying drawings, and specific embodiments in which the invention may be used are shown by way of illustration. It is to be understood, however, that other embodiments may be utilized and that various changes may be made without departing from the spirit and scope of the present invention. The following description is, therefore, not to be taken in a limiting sense.

FIG. 1 is diagram illustrating one pathway that generates a sensation of pain in a muscle that has been exercised.

FIG. 2 is a diagram showing the action of the disclosed technology on the pathway described in FIG. 1.

FIG. 3 is an illustration of a wearable garment that may implement the disclosed techniques for reducing pain during intense exercise.

FIG. 4 shows five (5) different potential configurations of the wearable garment introduce in FIG. 3.

FIG. 5 shows a battery pack that may be used to provide power to the garments of FIGS. 3 and 4.

FIG. 6 is an illustration of a control panel that amy be employed to control the garments of FIGS. 3 and 4.

FIG. 7 is an illustration of a control panel implemented as a telephone application, or “app.”

### DETAILED DESCRIPTION OF THE FIGURES

Although described with particular reference to a wearable garment, the claimed subject matter can be implemented in any application in which it may be necessary to apply stimulation to a muscle or group of muscles. It should be understood that the term “garment” may include a wearable mesh that incorporates the disclosed technology. Those with skill in the relevant arts will recognize that the disclosed embodiments have relevance to a wide variety of environments in addition to those described below. In addition, the methods of the disclosed technology can be implemented a combination of software and hardware. The hardware portion can be implemented using specialized logic; the software portion can be stored in a memory and executed by a suitable instruction execution system such as, but not limited to, a microprocessor, personal computer (PC), smartphone or cloud computing.

When a body part is injured, we instinctively press and rub on the area to relieve the pain. While it has been difficult to prove gate control theory, Melzack and Wall’s article (Science 1965,19 November 1965, Vol 150, Number 3699) has survived as the best explanation of this phenomenon thus far. In short, they suggested that the application of nonpainful stimuli in the same area of painful stimuli could reduce the sensation of pain. As the Inventor herein have realized, this theory has never been applied to the action of reducing pain during exercise, only before and after the exercise. In U.S. Pat. No. 10,159,623, issued Sep. 25, 2018, Leftly describes a device that applies vibrations to muscles either before or after exercise but not during. As the Inventor herein has realized, unexpected results are achieved when such vibrations are introduced during exercise, specifically by enabling a human to exceed the limits previously caused by muscle pain.

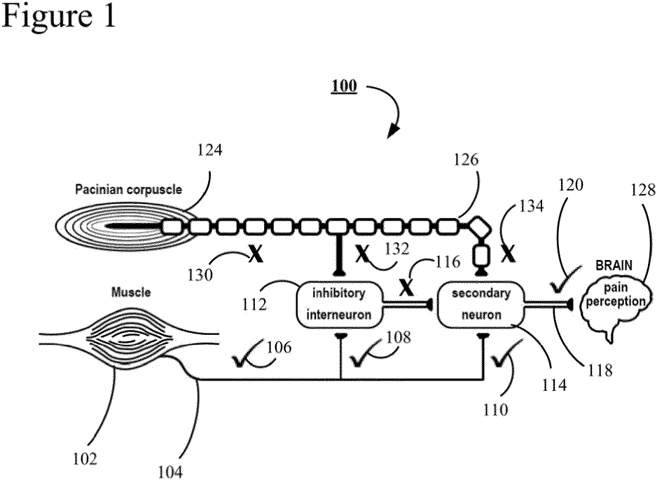

FIG. 1 is diagram illustrating a neuro pathway 100 that generates a sensation of pain in a muscle 102 that has been exercised when vibration is not applied in accordance with the claimed subject matter. When muscle 102 becomes fatigued, or “burns,” a pain fiber, or C-fiber, 104, which is a small, unmyelinated, nociceptor, transmits a signal, represented by checkmarks, or ‘✔’, 106, 108 and 110 to an inhibitory interneuron 112 and secondary neuron 114. In this case, inhibitory interneuron 112 does not activate secondary neuron 114, as indicated by an “X” symbol 116. When secondary neuron 114 is activated by signal 104 but not by inhibitory interneuron 112, a signal 118 is sent, as indicated by a checkmark 120, to a person’s brain 128 where the signal 118 is perceived as pain. In other words, in the absence of vibration applied in conformity with the disclosed technology, a Pacinian corpuscle 124 does not transmit a signal to either inhibitory interneuron 112 or secondary neuron 114 along a large, AB fiber, myelinated, non-nociceptor 126 to either inhibitory interneuron 112 or secondary neuron 114 as indicated by a number of ‘X’ marks 130,132 and 134.

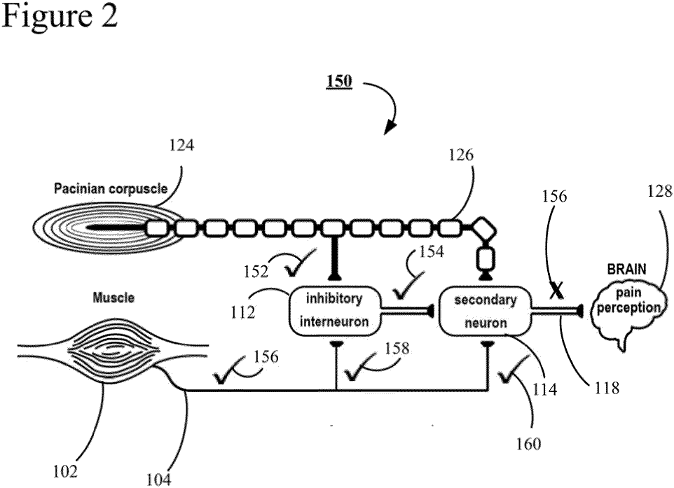

FIG. 2 is diagram illustrating a neuro pathway 150 that blocks a sensation of pain in muscle 102 (FIG. 1) that has been exercised when vibration is applied in accordance with the claimed subject matter. Line FIG. 1, FIG. 2 includes muscle 102, pain fiber 104, inhibitory interneuron 112, secondary neuron 114, signal 118 and brain 128, Pacinian corpuscle 124 and large, AB fiber, myelinated, non-nociceptor 126.

As described above in conjunction with FIG. 1, when muscle 102 begins to “burn”, C fiber (pain) 104 transmits signal represented by checkmarks 156, 158 and 160 to inhibitory interneuron 112 and secondary neuron 114. However, with local application of vibration to Pacinian corpuscle 124, Pacinian corpuscle 124 detects the vibration simultaneously sending a signal represented by a checkmark 152 along A-beta fibers 126 to inhibitory interneuron 112, which signals secondary neuron 114 as indicated by checkmark 154. In this case, secondary neuron 114 is inhibited from sending a pain signal to brain 128, as indicated by an ‘X’ 156.

More specifically, the A-beta fibers 126 reach and ascend the spinal cord ipsilaterally but give off collateral fibers in the substantia gelatinosa near secondary neuron 114. C and A-delta pain fibers 104 and 126, respectively, also synapse in this region. Pain fibers 104 deliver glutamate (from A-delta fibers 126) and substance P (from C-fibers 104) to secondary neuron 114 to activate it. Secondary neuron 114 crosses the spinal cord and ascends to the thalamus along the spinothalamic tract synapsing with a tertiary neuron that ascends to the postcentral gyrus of the parietal lobe where it is perceived as pain. Although not shown, the spinal cord, collateral fibers, substantia gelatinosa, glutamate, substance P, thalamus, spinothalamic tract, tertiary neuron, postcentral gyrus and parietal lobe should be familiar to those with skill in the relevant arts.

In short, Pacinian corpuscles 124 receive vibration signals along the DCML (dorsal column medial lenmiscal system) and send ascend ipsilaterally to the medulla where they cross over at the medial lemniscus. The key to gate control theory related to the disclosed application is the inhibitory effect of vibration on pain in the substantia gelantinosa.

Vibration signals travelling along a DCML collateral arrive at inhibitory interneuron 112. This then synapses with secondary neuron 114 as do the C and A-delta fibers 104 and 126, respectively. When activated by vibration, inhibitory interneuron 112 gives off Enkephalin that bonds with opioid receptors on C fiber 104 and A-delta fibers 126. This causes closure of Ca++ channels leading to a decreased release of glutamate and substance P decreasing excitation of the secondary neuron. Enkephalin also bonds to opioid receptors on the secondary neuron opening K+ channels further reducing excitation of the secondary neuron. (The anatomic structures and physiological functions have been grouped here for simplicity. A detailed discussion of peptidergic and nonpeptidergic C-fibers along with an inventory of synapses in laminae I-V is beyond the scope of this work and doesn’t further the understanding of the function of our devices.)

The claimed subject matter depends on the vibration function of Pacinian corpuscles 124. These receptors 124 respond to dynamically changing mechanical stimuli and are best excited by vibrations of relatively high frequency (close to three hundred Hertz (300 Hz); Kandel et al. 2000) although they detect frequencies from one hundred fifty to four hundred Hertz (150-400 Hz). However, frequencies below one hundred fifty Hertz (150 Hz) also appear to provide some positive experimental results. The receptive ending is cylindrical and covered by several membranes giving it an onion-like appearance in cross-sections. Between the membranes, a viscous fluid determines the receptive properties of the ending. Constant pressure does not trigger the receptors, because the fluid moves away and the central cylinder is under static pressure. Alternating pressure stimuli with a fast onset and offset — such as vibrations — are transmitted to the core of the ending and excite it, because the fluid between the membranes is too viscous to move away quickly. Under these conditions, the receptor behaves like a solid structure that has a rigid connection between the concentric membranes and the receptive ending in the core of the corpuscle.

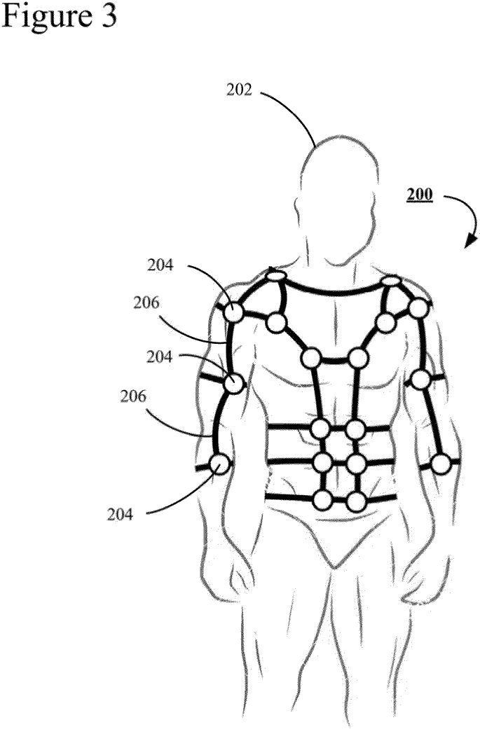

FIG. 3 is an illustration of a wearable garment 200 that may implement the disclosed techniques for reducing pain during intense exercise. Garment 200, in this example being worn by a person 202, includes vibrators, or buzzers, 204, which for the sale of convenience, only three of which are labeled. Vibrators 204 are interconnected, or networked, via connections 206, only two of which are labeled. Buzzers 204 are strategically positioned in garment 200 (“wearable’ to cover both for the purposes of description) to optimally vibrate the skin overlying the majority of adjacent muscle belly. Buzzers 204 are firmly imbedded in garment 200 to allow optimal delivery of vibration.

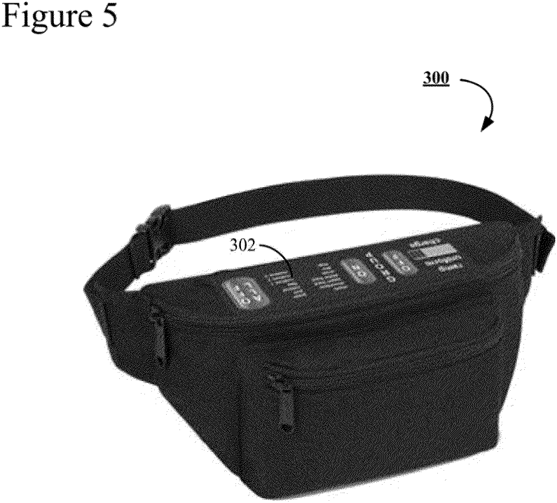

In one embodiment, buzzers 204 are one and one half inches (1.5”) in diameter and one half inch (½”) in thickness. Buzzers 204 in this embodiment may operate at variable frequencies from one hundred fifty to four hundred (150-400) Hz with amplitude variability. Buzzers 204 may vibrate in unison with all other buzzers 204 throughout wearable garment 200, thereby allowing optimal summation of vibration amplitude between buzzers 204 and potentially setting up standing waves, which, if desired, inelastic damping may mitigate this phenomenon. Buzzers 204 are connected through wearable garment 200 to a rechargeable power pack (see FIG. 5) that may be worn on the user’s 202 anterior waist.

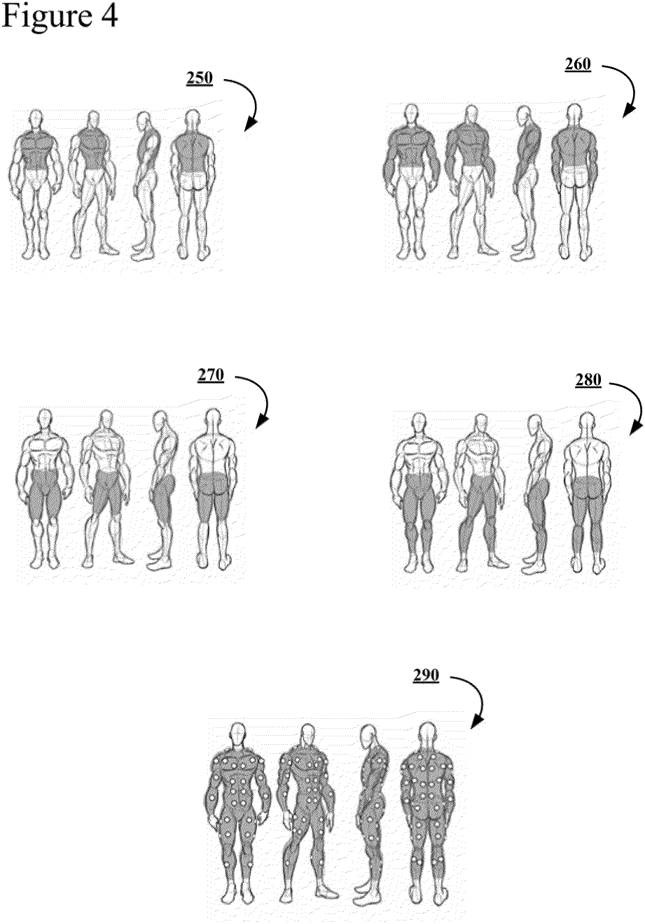

Garment 200, which is imbedded with buzzers 204, may be constructed of heavy duty, stretchable, nylon fabric in provided in various sizes. Malfunctioning buzzers 204 can be easily replaced. Heavy duty insulated wire (not shown) carries power to buzzers 204 and insulation (not shown) reduces heating. Adjacent wearables such as upper body wearables 250 and 260 (see FIG. 4) and lower body wearables 270 and 280 (see FIG. 4) may plug into each other. In one embodiment, garment 200 may be washed with the vibration units removed. Other potential embodiments may include waterproof buzzers 204, enabling garment 200 to be washed without removing buzzers 204.

FIG. 4 shows five (5) different potential configurations 250, 260, 270, 280 and 290 of wearable garment 200 introduced in FIG. 3. The configurations include a sleeveless shirt type garment 250, a sleeved shirt configuration 260, a knee-length configuration 270, a full pants configuration 280 and a full-body configuration 290. Buzzers 104 may be linked into groups depending upon the muscle 102 (FIGS. 1 and 2) or muscles exercised.

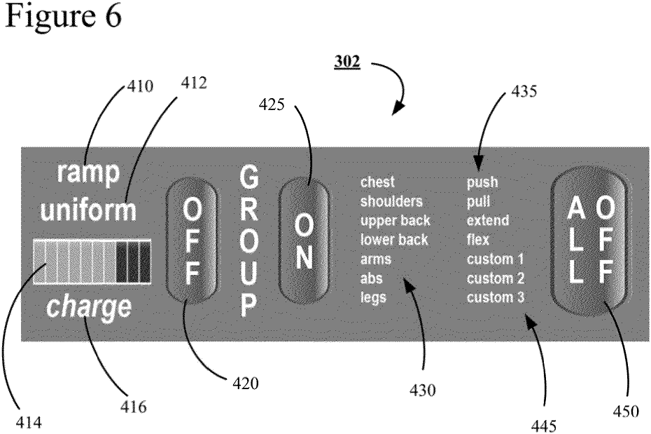

FIG. 5 shows a battery pack 300 that may be used to provide power to garments 200, 250, 260, 270, 280 and 290 of FIGS. 3 and 4. Power pack 300 is shown from the front and contains a battery (not shown) to power buzzers 204 (FIG. 3), an interface (see FIG. 6) to control buzzers 204, a power cable (not shown)) stored inside, and an accessory pouch (not shown) on the front to hold personal items. Battery pack 300 would typically strap around a user like a fanny pack but smaller. There may be a Velcro flap (not shown) that can be flipped up from behind battery pack 300 to cover a control panel 302.

Power pack 300 provides power to buzzers 204 through a network of cables. Power pack 300 may be charged by a connection to a standard one hundred twenty volt (120V) wall outlet taking about four (4) hours to charge completely from a depleted battery. Battery pack 300 may last about two (2) hours on continuous usage equivalent to about four (4) hours of exercise assuming the unit is off during half of a workout. On top of the battery pack 300 is control panel 302 for operating the garment 200, 250, 260, 270, 280 and 290. Power pack 300 plugs into the garment 200, 250, 260, 270, 280 and 290.

FIG. 6 is an illustration of a control panel 302 (FIG. 5) that may be employed to control garment 200, 250, 260, 270, 280 and 290 of FIGS. 3 and 4. In this embodiment, control panel 302 is positioned on battery pack 300 (FIG. 5) but may also be elsewhere in the alternative or in addition. Control panel 302 is an example of a configuration that may evolve as more convenient configurations and additional functionalities are developed. On interface 302, various functions of buzzer network 200, 250, 260, 270, 280 and 290 are grouped into a Ramp selection 410 that may progressively increases the amplitude and/or frequency of vibration during an exercise. A Uniform selection 412 resets buzzer network 200, 250, 260, 270, 280 and 290 to a pre-set uniform amplitude and/or frequency of vibration during an exercise. A bar graph 414 indicates a level of charge left on the battery. Charge 416 is the label of the charging bar. An OFF button 420 turns off the buzzers, or a buzzer group, that were on and an ON button 425 turns on the selected buzzer group.

A list of preset buzzer groups 430 lists a set of default buzzer groups, which in this group includes “chest,” “shoulders,” “upper back,” “lower back,” “arms,” “abs,” and “legs,” which correspond to chest muscles, shoulder muscles, upper back muscles, lower back muscles, arm muscles, abdominal muscles and leg muscles, respectively. By selecting one particular group, a user can specify a particular muscle or group of muscles to which to apply vibration. By means of a user interface (not shown), a user can specify a particular change the names of the groups and what buzzers are included in any particular group. Another list of defaults of 435 lists a default set of groups of buzzers based on the particular exercise type. In this example, the user may select muscles that apply to the exercise types associated with “push,” “pull,” “extend” and “flex.” Three additional selections 445, “custom 1,” “custom 2” and “custom 3,” enable the user to define and label their own groups of muscles. An ALL OFF selection 450 turns of all buzzers. All of the power pack elements are programmable through a phone app or computing device to which control panel 302 may be connected, either via wire or wireless.

It should be noted that different settings may allow for vibration to ramp up over a period of time to minimize acclimation to the vibration allowing the vibrations to work most toward the end of the set. Following exercise, lactic acid buildup pain disappears rapidly and any remaining pain is typically passive.

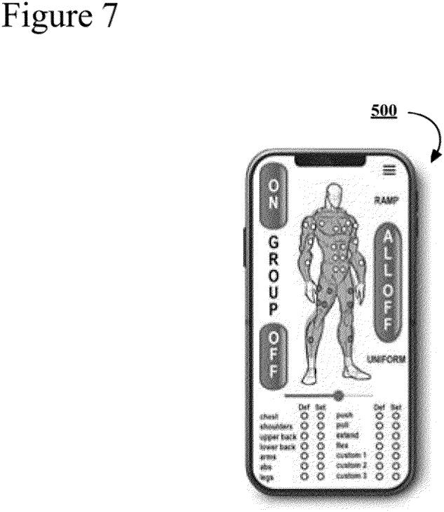

FIG. 7 is an illustration of a control panel 500 implemented as a telephone application, or “app.” Garment 200, 250, 260, 270, 280 and 290 may be controlled via control panel 500 set up and programmed from a telephone app. A user would usually control the wearable 200, 250, 260, 270, 280 and 290 from an interface on power pack 300 but a trainer may choose to control it from a phone interface such as control panel 500. User data from power pack 300 (FIG. 5) may be uploaded to the phone app while the phone app is running. Control panel 500 would typically provide all the functionality of control panel 302 (FIGS. 5 and 6).

While the claimed subject matter has been shown and described with reference to particular embodiments thereof, it will be understood by those skilled in the art that the foregoing and other changes in form and detail may be made therein without departing from the spirit and scope of the claimed subject matter, including but not limited to additional, less or modified elements.

We claim:

1. A garment for reduction of muscle pain during intense physical exercise, comprising:
a garment adapted to conform to a shape of a portion of a human body;
a plurality of interconnected vibrators incorporated into the garment at intervals throughout the garment;
a power source coupled to the plurality of vibrators;
an instruction execution system;
logic, executed on the instruction execution system and stored on a non-transitory electronic storage medium, the logic comprising instructions for controlling the plurality of vibrators to deliver vibrations to a user selected group of muscles of the human body during exercise.

2. The garment of claim 1, the logic comprising logic for controlling a selected subset of the plurality of vibrators, the selected subset corresponding to the user selected group of muscles.

3. The garment of claim 1, wherein the wearable garment comprises a mesh.

4. The garment of claim 1, wherein the vibrators are adapted to vibrate at a frequency between one hundred fifty and four hundred Hertz (150-400 Hz).

5. The garment of claim 1, wherein the vibrators are adapted to vibrate at a frequency between thirty and four hundred Hertz (30-400 Hz).

6. The garment of claim 1, wherein the portion of the human body is a torso of the human body.

7. The garment of claims 1, wherein the vibrators are adapted to be positioned over major muscle groups of the human body.

8. The garment of claims 1, further comprising a control panel for controlling a list of attributes of the vibrators, the list comprising:
on/off;
frequency;
amplitude; and
a selection of a particular muscle group corresponding to the selected muscles to which to apply vibration.

9. The garment of claim 1, the logic further comprising logic for storing data of a record of use of the garment.

10. The garment of claim 1, further comprising means for communicating with an external device.

11. The garment of claim 1, wherein the garment is a shirt.

12. The garment of claim 1, wherein the garment is pants.

13. A method for reduction of muscle pain during physical exercise, comprising:
selecting a group of muscles from a plurality of muscles of a human body;
positioning a plurality of vibrators, each vibrator of the plurality of vibrators positioned over a corresponding one of the muscles of the group of muscles; and
activating the plurality of vibrators during physical exercise.

14. The method of claim 13, further comprising selecting the group of muscles based upon a particular exercise.

15. The method of claim 13, further comprising incrementally increasing the amplitude of vibrations as an end of the physical exercise is approached.

16. The method of claim 13, the selecting the group of muscles comprising selecting from a list of muscle groups, the list of muscle groups comprising muscles corresponding to:
chest muscles;
shoulder muscles;
upper back muscles;
lower back muscles;
arm muscles;
abdominal muscles; and
leg muscles.

17. The method of claim 13, the selecting the group of muscles comprising selecting from a list of exercise types, the list of exercise types comprising:
push;
pull;
extend; and
flex.

18. The method of claim 13, further comprising incorporating the plurality of vibrators into a shirt.

19. The method of claim 13, further comprising incorporating the plurality of vibrators into pants.
